(19) United States
(12) Patent Application Publication
(10) Pub. No.: US 2014/0081459 A1
(43) Pub. Date: Mar. 20, 2014

(54) DEPTH MAPPING VISION SYSTEM WITH 2D OPTICAL PATTERN FOR ROBOTIC APPLICATIONS

(71) Applicants: Marc Dubois, Keller, TX (US); Thomas E. Drake, JR., Fort Worth, TX (US)

(72) Inventors: Marc Dubois, Keller, TX (US); Thomas E. Drake, JR., Fort Worth, TX (US)

(21) Appl. No.: 14/032,427

(22) Filed: Sep. 20, 2013

Related U.S. Application Data
(60) Provisional application No. 61/703,387, filed on Sep. 20, 2012.

(51) Int. Cl. B25J 9/16

(52) U.S. Cl. CPC B25J 9/1697
USPC 700/259

(57) ABSTRACT

A depth mapping device equipped with a 2D optical pattern projection mounted on a tool attached to a robot may be used to measure distance between the tool and an object. Depth data generated by the depth mapping device can be used to generate an augmented-reality image to provide real-time information about the object position, orientation, or other measurements to an operator performing a industrial robotic process. Images also may be generated with a camera located on the robot. Real-time depth information may be used to prevent collision. Fast depth information acquisition may be used to modify robot position for better processing. Real-time data acquisition plus fast processing may provide augmented-reality images to operators for better robot programming. Location data of the industrial process on the object may be used to improve analysis of the industrial process data.

### CROSS-REFERENCE TO RELATED APPLICATION

The present application claims the benefit of U.S. Provisional Application No. 61/703,387 entitled “Depth Mapping Vision System with 2D Optical Pattern for Robotic Applications,” filed Sep. 20, 2012, the disclosure of which is hereby incorporated by reference in its entirety.

### FIELD OF THE DISCLOSURE

The present disclosure generally relates to systems and methods for depth measuring and more particularly depth measuring for robotic applications.

### BACKGROUND

Robots are becoming increasingly popular for industrial applications. In particular, articulated robots that were initially massively used in the automotive industry are now being used in a constantly increasing number of different industrial applications. In several robotic applications, it is important for the operator programming the robot to know the distance between an object and the tool moved by the robot. For example, in an application such as laser-ultrasonic inspection, the laser-ultrasonic tool should be positioned within a certain distance range from the object. In several other applications such as machining, welding, and fiber lay-up, the distance between the tool and the object may be important as well. Furthermore, knowledge of the orientation of the object surface may be used to better program the robot. For example, in a welding application, the welder tool moved by the robot should follow the surface of the object. In another example, orientation of object surface relative to the incident laser beams is important in laser-ultrasonic applications to obtain valid data. The information about the orientation of an object may be used to better position the laser-ultrasonic tool for more efficient inspections. Also, in some other robotic applications, it might be useful to know the position of the point on the object where the industrial process was applied. For example, in an application like laser-ultrasonic inspection of composites, the quantitative knowledge of the position where the laser beams were on the part at the time of each measurement can be used to reconstruct the laser-ultrasonic results in the coordinates of the object itself, like the CAD coordinates, for example. This reconstruction may help to determine the exact area of the object where the results come from and may help to ensure that for several robot positions, the object has been fully inspected. Finally, in all robotic applications, the ability to obtain the depth in front of the tool in real-time may be used to prevent collision between the tool and any object in the process room.

Information about an object position may be very important for industrial processes. Some information may currently be obtained by various methods. A first method may comprise positioning the part very accurately relative to the robot. This method may require having access to mechanical supports that are precisely adapted to the object. This method may generally be very expensive because of the requirements to manufacture and store the mechanical supports. Additionally, this method may lack flexibility because the industrial process can be performed only on objects for which a mechanical support has been previously designed and manufactured. Another approach may comprise measuring the position of the object using mechanical devices. Typically, a special robot tool may be attached to the robot and the robot may be moved in order to touch some pre-determined points on the object or on the mechanical support of the object. This method may be time consuming. This method may also lack flexibility because the process by which the position is measured must be previously designed and the required tool must be available. Another method may comprise having an operator perform distance measurements using a tape measure or some other type of mechanical measurement device. This method may only be useful during robot programming and may suffer from a lack of accuracy. Lack of accuracy associated with this method may be acceptable for some industrial processes that have relatively large position tolerances like laser-ultrasonic inspection. This method may also lack the ability to provide data on the location points on the object of the industrial process. Another method may comprise having the tool equipped with a single point depth measurement system. This approach can be very accurate at one point but may not provide the operator with a sense of the whole object position and orientation from a single view. In some cases, it might be possible for the single point measurement to be acquired simultaneously with the industrial process on the object. If such acquisition is possible, the industrial process location on the object can be known. However, this information may be available only after completion of the industrial process and may therefore not be available to facilitate robot programming or for position or orientation correction prior to the completion of the industrial process.

Some depth mapping devices may use triangulation or stereo vision. For example, depth information can be obtained by projecting a light pattern such as a line strip and reading the reflected light by a camera at a slightly different point of view. This approach can achieve high accuracy but typically requires several seconds to scan the line stripe. This approach may also require a motorized system to move the line stripe. Stereo systems that use two cameras can achieve high accuracy at high repetition rates. However, stereo systems may depend on the texture of the objects to be measured. Texture can be construed to include any object features captured by a camera when observing the object under ambient or controlled illumination and is similar to what would be observed by photographing the object. These features are created by variations in colors and physical shapes of the object for example. In several industrial applications, texture is lacking and stereo systems cannot work, such as when observing a flat featureless part of uniform color. This problem is typically overcome by applying stickers on the object to create some sort of texture. The application of those stickers may be time-consuming. Furthermore, it is often necessary to remove the stickers before the start of the industrial process, making this method even more time-consuming.

### SUMMARY

Embodiments of the present disclosure may provide a depth-measuring system for robotic applications including a robot, a tool attached to the robot and having a reference point, an illuminator that emits energy according to a two-dimensional pattern installed on the tool to illuminate an object, and at least one energy receiver that is installed on the tool and receives at least some energy reflected by the object in response to the energy emitted by the illuminator. The tool reference point may have a spatial relationship with the coordinate system of the robot. The at least one energy receiver may comprise a two-dimensional sensor that is sensitive to the energy emitted by the illuminator. The at least one energy receiver may have a pre-determined spatial relationship with the reference point on the tool and the energy illuminator. The system may further comprise a first processor unit located on the tool that uses the energy received by the at least one energy receiver to determine the distance between the at least one energy receiver and at least one point on the object. The system also may comprise a camera installed on the robot and having a pre-determined spatial relationship with the at least one energy receiver, wherein the camera acquires images of the object and its surrounding environment. At least one pixel of an image acquired by the camera may be associated to at least one data point provided by the at least one energy receiver to produce a second image. Associated in this context means the energy receiver provides a depth value for at least one pixel of the image because of the pre-determined spatial relationship between the energy receiver and the camera. The second image may be modified by a processing unit to add distance or orientation information to create a third image. The system may form part of an ultrasonic testing system. Ultrasonic energy may be generated in the object along an optical path originating from a point, wherein the point may have a pre-determined spatial relationship with the tool reference point. The position of the point where ultrasonic energy is generated in the object may be determined using information provided by the at least one energy receiver, a pre-determined relationship between the at least one energy receiver and the tool reference point, and controllable parameters of the optical path. Distance information may be provided by the at least one energy receiver, the distance information being used to calculate the surface normal of at least one point on the object. The distance information may be used to make a real-time determination of whether the object lies within a pre-determined range of distance or orientation. The tool may further comprise a rotation axis. The at least one energy receiver may be mounted on a portion of the tool that rotates relative to the robot. The system may further comprise a second processing unit that calculates the position of at least one point of the object relative to the reference point using distance information provided by the first processing unit and a pre-determined spatial relationship between the reference point and the at least one energy receiver.

Embodiments of the present disclosure may provide a method to perform an industrial process comprising moving a robot near an object, acquiring a two-dimensional (2D) array of depth data using a depth mapping device and a 2D optical pattern, performing an industrial processing step on the object, using the 2D array of depth data to determine the location of the industrial processing step being performed on the object and to generate coordinates of the location, and storing the depth data and the coordinates of the location of the industrial processing step being performed on the object.

Embodiments of the present disclosure may provide a method to perform an industrial process comprising moving a robot near an object, acquiring depth data using a depth mapping device and a 2D optical pattern, acquiring a texture image using a camera having a pre-determined spatial relationship with the depth mapping device, and associating a portion of the pixels of the texture image with a portion of the depth data using a calibration located on the depth mapping device and the pre-determined spatial relationship. The method may further comprise determining a three-dimensional (3D) spatial coordinates of a portion of the depth data relative to a coordinate system of the depth mapping device using a calibration provided by the depth mapping device. The method also may comprise determining 3D spatial coordinates of a portion of the depth data relative to a reference coordinate system that differs from the one of the depth mapping device. The method may further comprise modifying at least a portion of the pixels of the texture image based on range values calculated using 3D spatial coordinates relative to the reference coordinate system.

### BRIEF DESCRIPTION OF THE DRAWINGS

For a more complete understanding of this disclosure, reference is now made to the following description, taken in conjunction with the accompanying drawings, in which:

FIG. 1 depicts a robotic system equipped with a depth mapping device and a 2D optical pattern in front of an object according to an embodiment of the present disclosure;

FIG. 2A depicts a tool and depth mapping device according to an embodiment of the present disclosure;

FIG. 2B depicts a tool equipped with a depth mapping device and performing an industrial process on an object according to an embodiment of the present disclosure;

FIG. 3A depicts a depth mapping device according to an embodiment of the present disclosure;

FIG. 3B depicts a depth mapping device according to another embodiment of the present disclosure;

FIG. 3C depicts a depth measuring device according to an embodiment of the present disclosure;

FIG. 3D depicts generation of arrays according to an embodiment of the present disclosure;

FIG. 4A depicts a robotic system according to an embodiment of the present disclosure;

FIG. 4B depicts a robotic system according to another embodiment of the present disclosure;

FIG. 5 depicts a flow diagram for performing a robotic industrial process using an augmented-reality image feedback according to an embodiment of the present disclosure;

FIG. 6 depicts a flow diagram for performing a robotic industrial process according to an embodiment of the present disclosure; and

FIG. 7 depicts images of a composite part generated using a depth mapping device according to an embodiment of the present disclosure.

### DETAILED DESCRIPTION

Embodiments of the present disclosure may use a depth mapping device equipped with a two-dimensional (2D) optical pattern projection mounted on a tool attached to a robot to measure distance between the tool and an object. The depth data generated by the depth mapping device are in the form of a 2D array where each depth value of the array corresponds to a specific point in the three-dimensional (3D) coordinate space (x, y, z). The depth data can be used to generate an augmented-reality image to provide real-time information about the object position or orientation to an operator undertaking steps of an industrial robotic process. In an embodiment of the present disclosure, position and orientation information of the object generated by the device and a first image from a camera located on the robot may be used to generate a new image based on the first image that may have additional visual information encoded into it that may provide the operator with information based on the depth information that may not be apparent in the first image. In an embodiment of the present disclosure, depth information may be used to calculate the exact position of the points on the object where the industrial process was performed. In an embodiment of the present disclosure, the exact position may be determined using a reference point in the robotic tool and the known parameters of the industrial process. In another embodiment of the present disclosure, position data can be stored and used to improve the industrial process as a real-time feedback or position data can be used to plot the data of the industrial process in a 3D environment like a CAD model. In an embodiment of the present disclosure, real-time depth information may be used to prevent collision. In another embodiment of the present disclosure, fast depth information acquisition may be used to modify robot position for improved processing in real-time. In an embodiment of the present disclosure, real-time data acquisition plus fast processing may provide augmented-reality images to operators for better robot programming. In still another embodiment of the present disclosure, location data of the industrial process on the object may be used to improve analysis of the industrial process data.

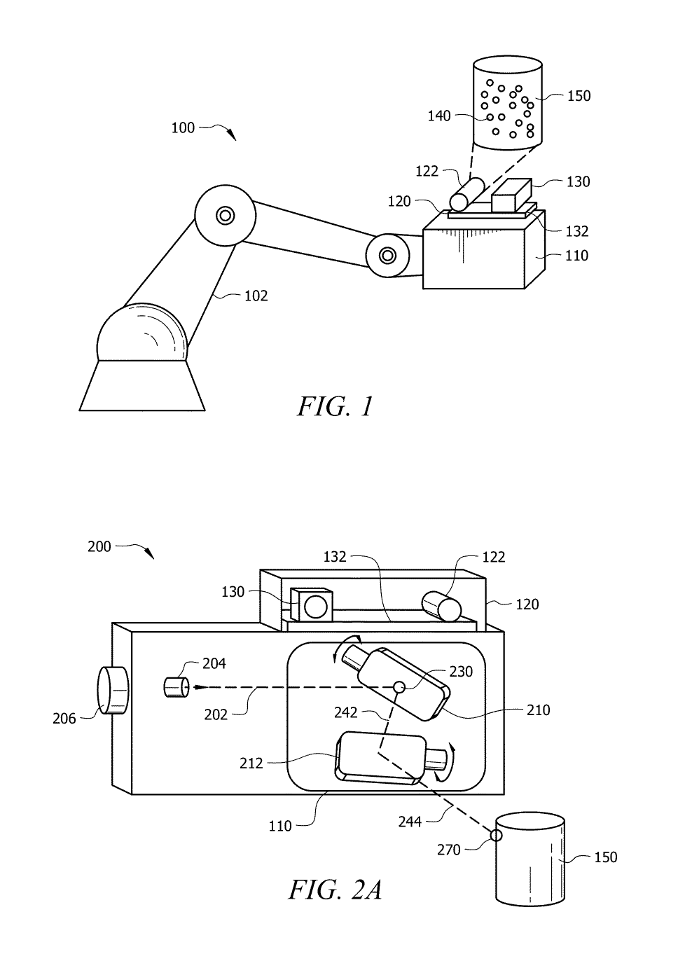

Referring to FIG. 1, robotic system 100 with depth mapping device 120 is depicted in front of object 150. Robot 102 is depicted as an articulated robot for illustrative purposes, but robot 102 may comprise any other suitable type of mechanical positioning system including, but not limited to, gantry, wheel-equipped robots, and telescoping arms. Tool 110 may be coupled to robot 102. In various embodiments of the present disclosure, tool 110 may be any tool configured to accomplish some process on object 150. In an embodiment of the present disclosure, the process may be any industrial process involving robots. Examples may include, but are not limited to, machining, drilling, inspection, fiber lay-up, laser cutting, non-destructive inspection, painting, coating application, and shape measurement.

Tool 110 may be equipped with depth mapping device 120. In an embodiment of the present disclosure, depth mapping device 120 may be equipped with pattern illuminator 122 that emits optical energy into a fixed 2D pattern 140 on object 150, and energy receiver 130. Energy receiver 130 is sensitive to the optical energy of pattern illuminator 122. In an embodiment of the present disclosure, pattern illuminator 122 may be maintained in a pre-determined spatial relationship relative to energy receiver 130 by mechanical holder 132. In an embodiment of the present disclosure, pattern illuminator 122 may comprise a light source projecting an uncorrelated or random 2D pattern 140. In various embodiments of the present disclosure, 2D pattern 140 may comprise spots or a plurality of parallel bands. In various embodiments of the present disclosure, 2D pattern 140 may comprise a dot pattern where the dots are uncorrelated in a pseudo-random or random pattern, dot pattern where dots have variable duty cycles, or a line pattern with periodicity, no-periodicity, or quasi-periodicity. It should be recognized that the present disclosure is not limited to the aforementioned pattern embodiments. In various embodiments of the present disclosure, the light source in may comprise a laser or a laser diode operating at visible or invisible wavelengths. In various embodiments of the present disclosure, 2D pattern 140 may be constant in time or may be varying as a function of time. Energy receiver 130 may comprise a 2D sensor. In an embodiment of the present disclosure, energy receiver 130 may be configured to detect some elements of 2D pattern 140 reflected from object 150. Energy receiver 130 may further comprise a CMOS camera or CCD camera. In an embodiment of the present disclosure, mechanical holder 132 may provide for the removal of depth mapping device 120 from tool 110 while maintaining the pre-determined spatial relationship between pattern illuminator 122 and energy receiver 130. In an embodiment of the present disclosure, depth mapping device 120 may be removed from tool 110 while maintaining their respective pre-determined spatial relationships if subsequently reinstalled. In another embodiment of the present disclosure, mechanical holder 132 may be an integrated part of tool 110.

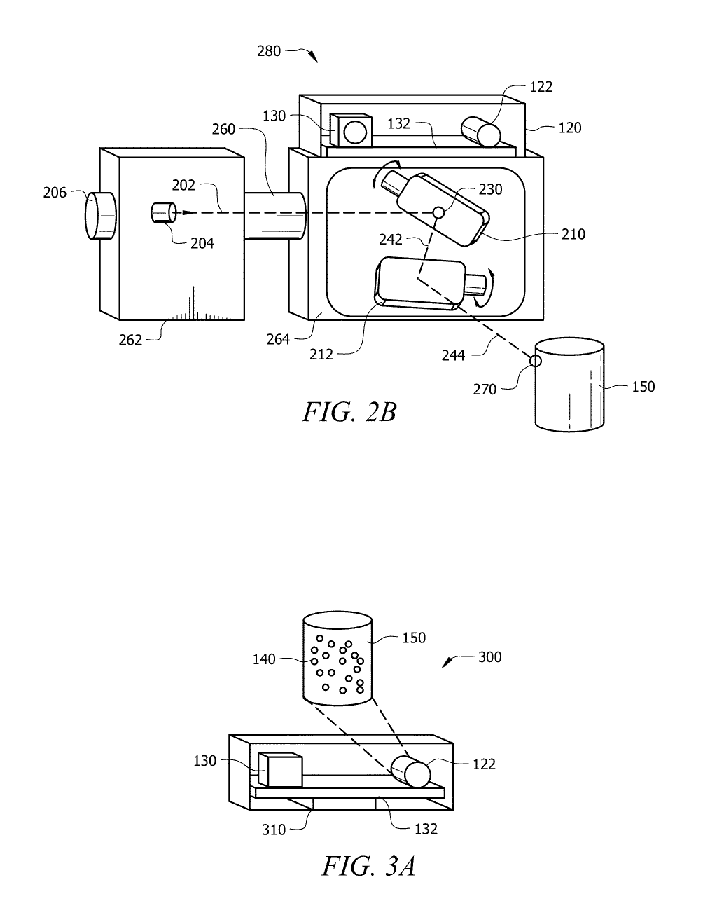

Referring now to FIG. 2A, assembly 200 is depicted according to an embodiment of the present disclosure. Assembly 200 may comprise tool 110, depth mapping device 120, and robot 102 (FIG. 1). In an embodiment of the present disclosure, tool 110 may couple with robot 102 at attachment 206. Assembly 200 may be configured to perform an industrial process on object 150. In an embodiment of the present disclosure, tool 110 may comprise first and second optical elements 210 and 212, and at least one optical beam 202. In an embodiment of the present disclosure, first and second optical elements 210 and 212 may comprise mirrors and optical beam 202 may comprise a virtual optical beam path or an actual laser beam. However, it should be appreciated that any other suitable type of industrial tool could be used without departing from the present disclosure. In an embodiment of the present disclosure, optical beam 202 may originate from optical origin point 204 inside tool 110 and may be directed to hit reference point 230. In an embodiment of the present disclosure, reference point 230 may comprise the center of first optical element 210. Optical origin point 204 and the orientation of optical beam 202 may remain substantially fixed relative to reference point 230. Energy receiver 130 within depth mapping device 120 may have a pre-determined spatial relationship relative to reference point 230. First optical element 210 may rotate and may be configured in such a way that when first optical element 210 rotates, reference point 230 may remain essentially fixed relative to optical origin point 204. In an embodiment of the present disclosure, this may be accomplished by making a rotation axis of first optical element 210 lay on the surface of first optical element 210 and by making reference point 230 coincide with both the surface and rotation axis of optical element 210. However, it should be appreciated that reference point 230 may not coincide with an actual mechanical or optical point in some embodiments of the present disclosure. Rather, reference point 230 may be virtual and correspond to any fixed point relative to tool 110 and to energy receiver 130 without departing from the present disclosure.

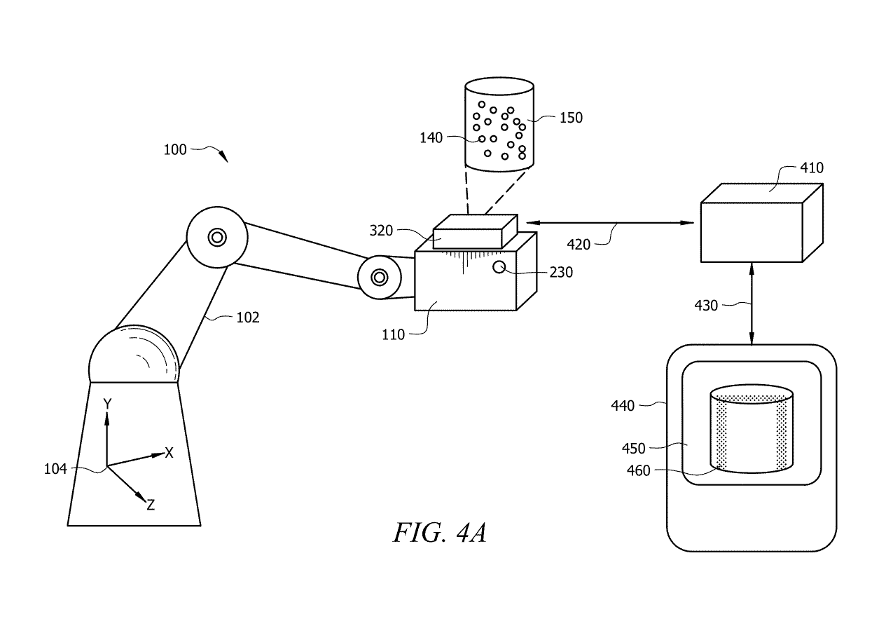

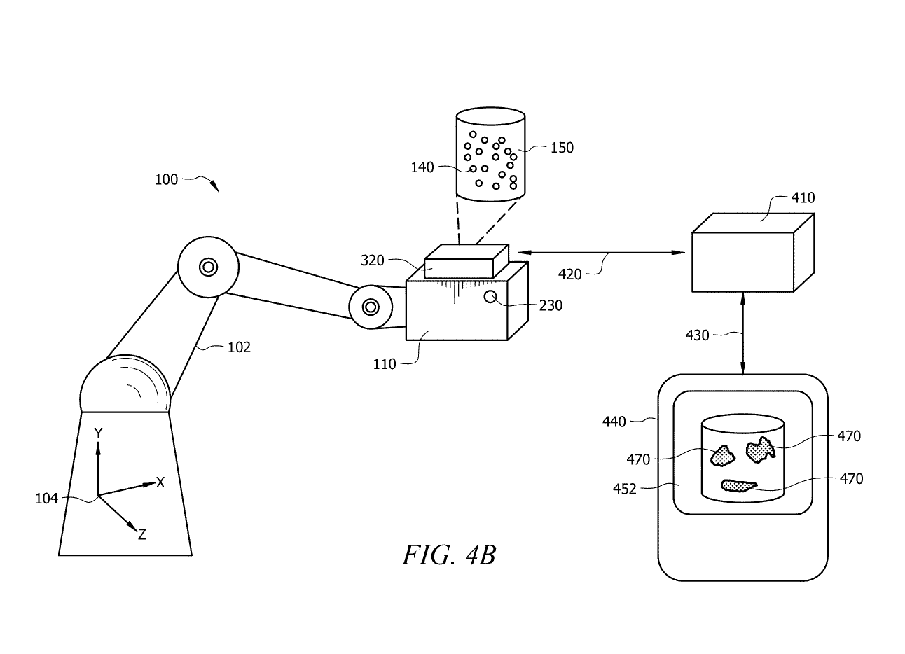

After being reflected by first optical element 210, optical beam 202 may be directed to second optical element 212. In an embodiment of the present disclosure, an orientation of optical beam section 242 may not be fixed relative to reference point 230 and may depend on orientation of first optical element 210. After being reflected by second optical element 212, optical beam section 244 may be directed to object 150. In an embodiment of the present disclosure, the orientation of optical beam section 244 may not be pre-determined relative to reference point 230 and may depend on the orientations of first and second optical elements 210 and 212. In an embodiment of the present disclosure, optical beam section 244 may hit the surface of object 150 at point 270. Position of point 270 on object 150 may depend on orientations of first and second optical elements 210 and 212 and on the position of object 150 according to embodiments of the present disclosure. The position of object 150 may be measured by depth mapping device 120 relative to reference point 230, and the orientations of first and second optical elements 210 and 212 may be known because they are controlled by a remote processing unit 410 (see FIG. 4). For any given orientations of first and second optical elements 210 and 212, there may be a single point in space corresponding to any specific distance or depth relative to reference point 230. Therefore, using the orientations of first and second optical elements 210 and 212, and using the distance information provided by depth mapping device 120, the position (3D spatial coordinates) of point 270 at surface of object 150 can be calculated. For example, if tool 110 comprises a laser-ultrasonic head for ultrasonic inspection of composites, optical beam 204 could substantially correspond to the generation laser beam. The generation laser beam may substantially follow the path shown by optical beam 204, including optical beam section 242 and 244, and hit object 150 (a composite part in the present embodiment) at point 270. Point 270 may become an energy generator in the object, and the energy may include ultrasonic energy. The energy generator may not have a pre-determined spatial relationship associated with the energy receiver 130 (energy reception mechanism) because the position of the energy generator may depend on the orientations of first and second optical elements 210 and 212 (mirrors in the case of a laser-ultrasonic system) and on the position of the object.

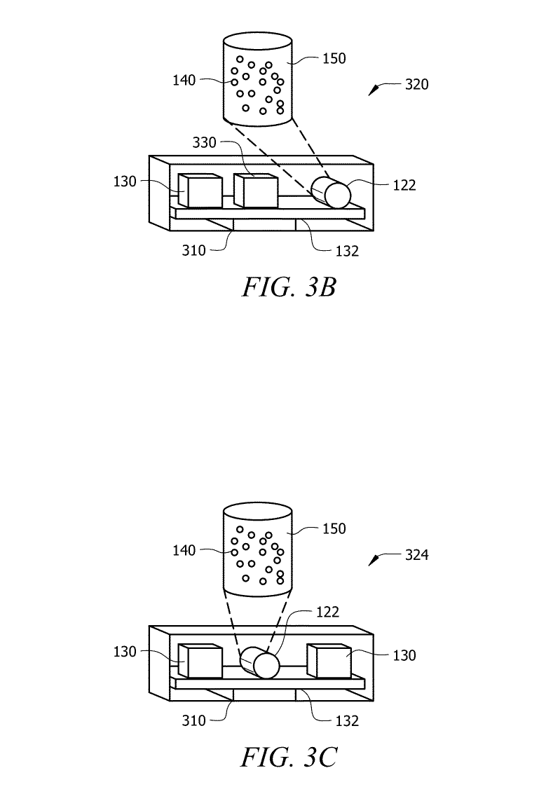

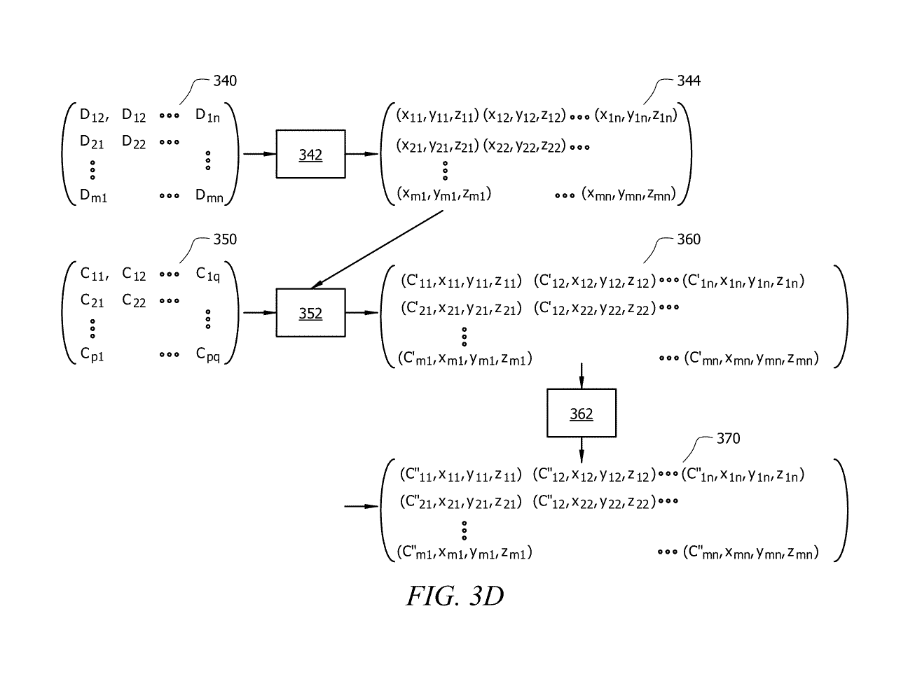

The location of point 270 at surface of object 150 may be determined using the parameters of the system and the information provided by depth-mapping device 120. In that case, ultrasonic results corresponding to point 270 can be associated to a specific point in space specified by the 3D spatial coordinates (x, y, z). This information can be used to represent ultrasonic results in an augmented-reality image according to a process similar to the one shown in FIG. 3D.

Referring now to FIG. 2B, assembly 280 is depicted according to an embodiment of the present disclosure as comprising tool 110 equipped with depth mapping device 120 and performing an industrial process on object 150. Tool 110 may comprise tool section 262 that may be attached to robot 102 (see FIG. 1) at attachment 206 and tool section 264 that may be attached to tool section 262 through rotation axis 260. In an embodiment of the present disclosure, rotation axis 260 may be controlled by a remote processing unit and the orientation of tool section 264 may be known relative to tool section 262. Depth mapping device 120 may be mounted on tool section 264. FIG. 2B depicts a laser-ultrasonic system according to an embodiment of the present disclosure. The axis of rotation axis 260 may coincide with optical beam 202. In this embodiment of the present disclosure, reference point 230 at surface of optical element 210 may coincide with both the surface and rotation axes of optical element 210. Therefore, the position of reference point 230 may remain the same relative to tool section 262 for all orientations of rotation axis 260. However, reference point 230 may not necessarily coincide with the axis of rotation axis 260 or with any actual mechanical or optical point. Rather, reference point 230 may be virtual and may correspond to any fixed point relative to tool section 264 and to energy receiver 130. The position and orientation of reference point 230 relative to tool section 262 may be calculated using the known value of rotation axis 260.

Referring now to FIG. 3A, depth mapping device 300 is depicted according to an embodiment of the present disclosure. Depth mapping device 300 may comprise energy receiver 130, pattern illuminator 122, mechanical support 132 and processing unit 310. Depth mapping device 120 may be equipped with pattern illuminator 122 projecting fixed 2D pattern 140 on object 150 and energy receiver 130. Pattern illuminator 122 may be maintained in a pre-determined spatial relationship relative to energy receiver 130 by mechanical holder 132. Pattern illuminator 122 may include, but is not limited to, a light source illuminating a 2D transparency containing an uncorrelated pattern of spots or a plurality of parallel bands.

In some embodiments of the present disclosure, 2D pattern 140 may comprise spots or a plurality of parallel bands. In other embodiments of the present disclosure, 2D pattern 140 may comprise a dot pattern where the dots are uncorrelated in a pseudo-random or random pattern, a dot pattern where dots have variable duty cycles, or a line pattern with periodicity, no-periodicity, or quasi-periodicity. It should be recognized that the present disclosure is not limited to the aforementioned pattern embodiments.

In various embodiments, the light source in pattern illuminator 122 may comprise a laser or a laser diode operating at visible or invisible wavelengths. Energy receiver 130 may comprise a 2D sensor. In an embodiment of the present disclosure, energy receiver 130 may be configured to detect some elements of 2D pattern 140 reflected from object 150. Energy receiver 130 may further comprise a CMOS camera or a CCD camera. In an embodiment of the present disclosure, mechanical holder 132 may provide for the temporary removal of depth mapping device 120 from tool 110 to maintain the pre-determined spatial relationship between pattern illuminator 122 and energy receiver 130 when depth mapping device 120 is installed back on tool 110. In another embodiment of the present disclosure, mechanical holder 132 may be an integrated part of tool 110. Processing unit 310 may receive information from energy receiver 130 and may calculate 2D array of depth values 340 (see FIG. 3D) using triangulation based on an internal calibration that takes into account the pre-determined spatial relationship between energy receiver 130 and pattern illuminator 122. It should be appreciated that the position of processing unit 310 shown in FIG. 3A is only for illustrative purposes and other positions may be provided without departing from the present disclosure.

Referring now to FIG. 3B, depth mapping device 320 is depicted according to an embodiment of the present disclosure. Depth mapping device 320 may comprise energy receiver 130, pattern illuminator 122, mechanical support 132, processing unit 310 and texture camera 330. A texture camera may be any camera that can acquire optical images where each pixel of the images contains an element of information about the image in which the information is a numerical value that can range between 0 and any value above 1. This type of camera includes, but is not limited to, color cameras and gray-level cameras. Depth mapping device 120 may be equipped with pattern illuminator 122 projecting 2D pattern 140 on object 150 and energy receiver 130. Energy receiver 130 may comprise a 2D sensor to detect some elements of 2D pattern 140 reflected from object 150. Processing unit 310 may receive information from energy receiver 130 and may calculate 2D array of depth values 340 (see FIG. 3D) based on an internal calibration that takes into account the pre-determined spatial relationship between energy receiver 130 and pattern illuminator 122. Using the appropriate calibration provided by processing unit 310 that is based on the pre-determined relationship between energy receiver 130 and pattern illuminator 122, 3D spatial coordinates (x, y, z) for data points of 2D array of depth values 340 can be obtained relative to energy receiver 130, shown as 2D position array 344 in FIG. 3D.

In an embodiment of the present disclosure, texture camera 330 may have a pre-determined spatial relationship with energy receiver 130. Texture camera 330 may comprise any suitable camera including but not limited to a 2D CCD or CMOS camera. Texture camera 330 may generate an image of object 150 and its environment as 2D image array 350 (see FIG. 3D). Processing unit 310 may contain a calibration that can be used to associate elements of image from texture camera 330 to specific elements of information provided by energy receiver 130. For example, texture camera 330 can be a regular optical camera with a 2D sensor such as a CMOS or a CCD, and optical receiver 130 can be a camera with a 2D sensor sensitive to the wavelength of 2D optical pattern generator 122. Calibration stored on processing unit 310 based on the pre-determined spatial relationship between energy receiver 130 and texture camera 330 may provide for remote processing unit 410 (shown in FIG. 4) to determine which data point of 2D image array 350 corresponds to which data point of 2D array of depth values 340 or 2D position array 344. In various embodiments of the present disclosure, this correspondence can be done for all pixels, providing a visual image of object 150 and its environment. It should be appreciated that positions of processing unit 310 and texture camera 330 shown in FIG. 3B are only for illustrative purposes and other positions may be provided without departing from the present disclosure.

Referring now to FIG. 3C, depth measuring device 324 is depicted according to an embodiment of the present disclosure. In an embodiment of the present disclosure, device 324 may have a configuration similar to depth measuring device 300 depicted in FIG. 3A but where two energy receivers 130 may be employed instead of a single one. When using two energy receivers, the accuracy of the overall depth measuring device can be increased by using stereoscopic information provided by the different views of 2D pattern 140 by two energy receivers 130. In that configuration, the relative position of two energy receivers 130 may be considered but the relative position of pattern illuminator 122 may not be. In that case, the pattern illuminator may not have a pre-determined spatial relationship with any of the two energy receivers 130 or with any other point on tool 110 (FIG. 1). In another embodiment, pattern illuminator 122 may not even have a fixed position, being allowed to somewhat move freely, or being actively moved, generating a moving 2D optical pattern on object 150. Movement of 2D optical pattern on object 150 may improve coverage and accuracy of the depth measurements. In another embodiment, pattern illuminator 122 generates a 2D optical pattern that is changing as a function of time to improve accuracy and coverage of depth measurements. In this case, depth data obtained from energy receivers 130 can be averages over some length of time. In a configuration similar to depth mapping device 320 of FIG. 3B, a texture camera can also be added to depth mapping device 324 to add color information but this embodiment is not illustrated here.

Referring now to FIG. 3D, depth mapping device 320 may generate 2D array of depth values 340 of size m by n containing data information about the distance between receiver 130 and object 150. First 2D array of depth values 340 may be transformed through processing step 342 into second 2D position array 344 of size m by n containing 3D spatial coordinates (x, y, z) corresponding to each of the points of first 2D array of depth values 340. Some of the information in arrays 340 or 344 might be missing and a specific value can be assigned to indicate such lack of information (negative or zero D or z value for example). 2D image array 350 may also be generated from depth mapping device 320 by texture camera 330. The size of 2D image array 350 is p by q that can be different from the m by n size of arrays 340 and 344. In an embodiment of the present disclosure, in processing step 352, at least one data point of 2D image array 350 is associated to at least one data point of arrays 340 and 344, by remote processing unit 410 using a calibration stored on processing unit 310 and the depth or z information at the corresponding point of arrays 340 or 344. The calibration may be based on the pre-determined spatial relationship between energy receiver 130 and texture camera 330. Processing step 352 may result in 2D array 360 that contains texture information C′ᵢⱼ and 3D spatial coordinates (xᵢⱼ, yᵢⱼ, zᵢⱼ). In processing step 362, remote processing unit 410 can use 3D spatial coordinates (xᵢⱼ, yᵢⱼ, zᵢⱼ) of at least one point or information of the neighbor points to calculate a physical parameter that is not apparent in first or second image. This object parameter can be, but is not limited to, distance, position, and orientation. Then, remote processing unit 410 can modify at least one C′ value according to the calculated object parameter into a C″ value. For example, the C′ value can be color-coded according to RGB (32-bit color code using hexadecimal number 0xRRGGBBYY where RR correspond to red intensity, GG to green intensity, and BB to blue intensity) and be modified by making a binary-OR operation with a RGB color corresponding to a specified range of the object parameter. For example, if the calculated object parameter is the distance between the tool and object, the C′ of each point can be binary-ORed with red RGB value (0xFF0000) if the distance is farther than the specified range, binary-ORed with the green RGB (0x00FF00) if the distance is within the specified range, and binary-ORed with blue RGB (0x0000FF) if the distance is closer than the specified range. Processing step 362 may result then in an augmented-reality image made of C″ values of 2D array 370 that shows the visual features of object 150 but with colors indicating if a particular point of object 150 is within a specified range, or closer or farther of that specified range. Similarly, if the location of an industrial process on object 150 is determined by depth mapping device 310, the results of this industrial process can also be encoded into the values C″ of 2D array 370 by processing step 362. The 2D array of values C″ extracted from 2D array 370 could then be shown as an image to an operator as feedback about the industrial process. Remote processing unit 410 can also in processing steps 352 or 362 transform the 3D spatial coordinates (x, y, z) values in the coordinate system of energy receiver 130, using translation and rotation tensor mathematics for example, into the 3D spatial coordinates (x′, y′, z′) in the coordinate system of the robot or of the process room. In that latter case, processing unit 410 could also remove specific elements of the image that have a known position in the process to facilitate the interpretation of the image by the operator. For example, remote processing unit 410 could remove the floor of the process room in the displayed image by changing 2D array 370 C″ RGB values to 0 for all data points of 2D array 370 that would have a z′ value equal or inferior at 0, assuming that the floor would coincide with z′=0.

Referring now to FIG. 4A, robotic system 100 is shown comprising a robot 102 that holds tool 110 according to an embodiment of the present disclosure. In an embodiment of the present disclosure, robot 102 may have coordinate system 104 that is fixed. Tool 110 may have reference point 230 that is fixed relative to tool 110. Depth mapping device 320 equipped with a texture camera that may be mounted on tool 110. Depth mapping device 320 may generate a set of data giving the distance between energy receiver 130 (see FIG. 3B) using energy from 2D optical pattern 140 reflected by object 150. Texture camera 330 in depth mapping device 320 may generate a first image of object 150. The distance data and first image generated by depth mapping device 320 may be communicated to remote processing unit 410 through communication link 420. Communication link 420 may comprise any suitable communication link including, but not limited to, a USB cable, a network cable, or a wireless connection link. Remote processing unit 410 may use the data provided by depth mapping device 320 to calculate the 3D spatial coordinates of at least one point of the object and may generate a second image where at least one pixel corresponds to at least one point of the 3D spatial coordinates of the object, the pixel having a color extracted from the first image using a relationship provided by processing unit 310 (see, e.g., FIG. 3B) of depth mapping device 320. In an embodiment of the present disclosure, the color of the at least one pixel of the second image can be modified according to some parameters calculated from the 3D data of that pixel and/or of its neighbors to generate augmented-reality image 450. For example, a pixel color be have its blue hue increased if the distance between the 3D spatial coordinates corresponding to that pixel and a reference point in robot coordinate system 104 or in tool 110 is within a certain range. Another example is to change a pixel color according to the surface normal of object 110 using the 3D spatial coordinates associated with that pixel and the 3D spatial coordinates associated to the neighbors of that pixel. The third image may become an augmented-reality image that may have features 460 giving more information like object distance or surface orientation than the first and second camera images.

Augmented-reality image 450 may be transmitted to display unit 440 through communication link 430. Communication link 430 may comprise any suitable communications link including, but not limited to, a USB cable, a network cable, an analog video cable, a digital video cable or a wireless communication link (such as Wi-Fi). Display unit 440 may comprise any suitable display including, but not limited to, a monitor, another processing unit, a cell phone, a tablet, and a handheld computer.

FIG. 4B depicts another embodiment of the present disclosure. In a process similar to the one explained for FIG. 4A, augmented-reality image 452 is generated and displayed by display unit 440. The second image is similarly generated by remote processing unit 410 using data provided by depth mapping device 320 to calculate the 3D spatial coordinates of at least one point of the object and the first image from texture camera 330. Augmented-reality image 452 is generated by modifying some pixels of second image to show results of an industrial process on object 150. The 3D spatial coordinates of some industrial process data points on object 150, are determined using the information provided by depth mapping device 320, in a manner similar to the one illustrated in FIGS. 2a and 2b for examples. Some of the industrial process data points are associated to pixels of the second image that have similar 3D spatial coordinates. The pixels of the second image that are associated to industrial data points have their color hues modified to indicate some information about the industrial process while maintaining information about the texture of object 150 and its environment. For example, some pixels of the second image can be modified to generate augmented-reality image 452 where the results of an ultrasonic inspection showing defects 470 in the object are overlaid over the texture image. Image 452 shown on portable display 440 can then be used by an operator to locate the positions of flaws on the actual part directly on the factory floor for example.

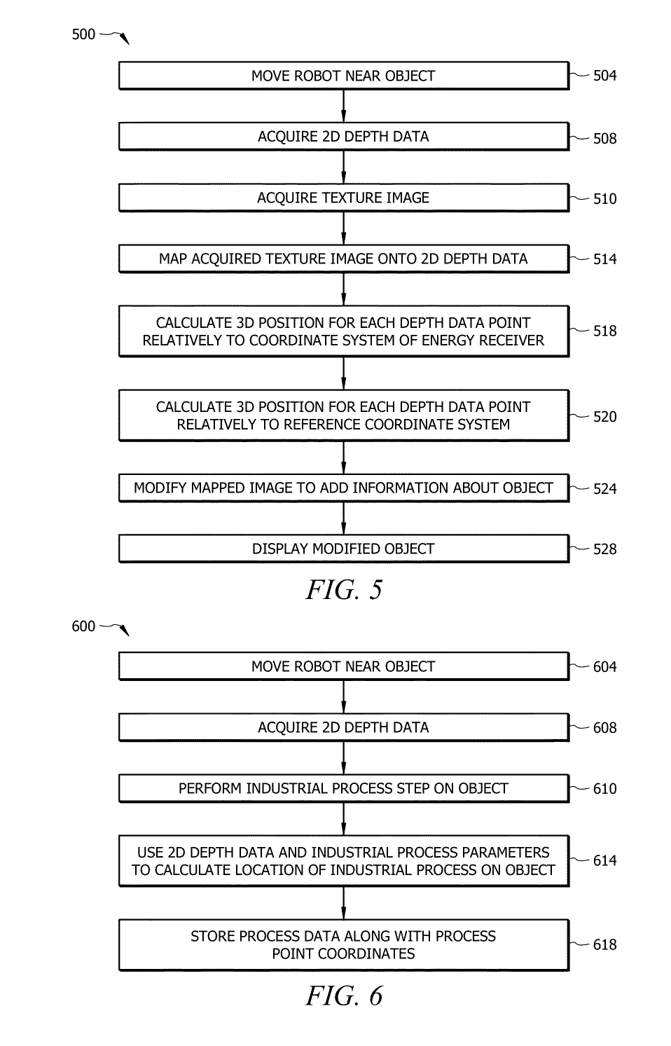

Referring now to FIG. 5, flow diagram 500 is shown comprising steps for performing a robotic industrial process using an augmented-reality image feedback in an embodiment of the present disclosure. In block 504, a robot on which a tool may be attached may be moved near an object. In block 508, a depth mapping device may acquire depth data of the object. In block 510, a camera may acquire a texture image of the object. In block 514, pixels of an acquired texture image may be associated to some portion of the depth data. In block 518, 3D spatial coordinates of at least some of the depth data may be calculated relative to the energy receiver of the depth mapping device. In block 520, the 3D spatial coordinates for each depth data point may be transformed into a new reference coordinate system. In block 524, some of the pixels of the acquired texture image may be modified in colors to provide information about the object. In block 528, the modified texture image may be displayed. The modified texture image may provide information about the shape, position, or orientation of the part to an operator. The modified texture image may also provide information about an industrial process that was applied to the part like an ultrasonic inspection. For example, the modified texture image may include results of an ultrasonic inspection overlaid with the texture image showing the location of flaws in an object. The modified texture image would then be useful to an operator to precisely locate flaws on the actual object. It should be recognized that the preceding method is illustrative, and the present disclosure should not be limited to any particular combination or sequence of steps described herein.

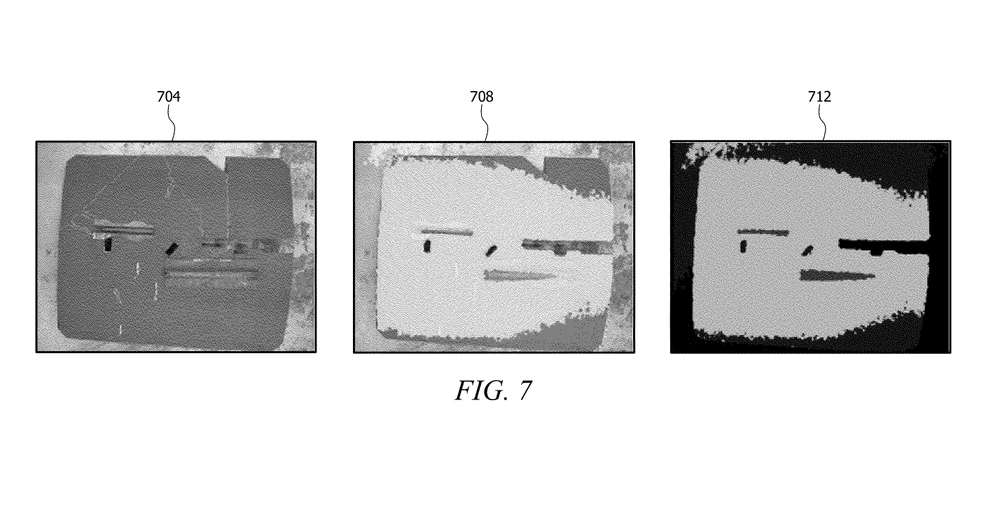

Referring now to FIG. 6, flow diagram 600 is shown comprising steps for performing a robotic industrial process where the exact location of the industrial process on an object is measured using a depth mapping device in an embodiment of the present disclosure. In block 604, a robot on which a tool may be attached may be moved near an object. In block 608, a depth mapping device may acquire depth data of the object. In block 610, one step of an industrial process may be performed on the object. In block 614, the depth data along with the industrial process parameters may be used to calculate the location on object of at least one point of the industrial process on object. In block 618, the location data (3D spatial coordinates of process point on object) may be stored along with industrial process data. It should be recognized that the preceding method is illustrative, and the present disclosure should not be limited to any particular combination or sequence of steps described herein.

Referring now to FIG. 7, examples of images of a composite part with two stringers generated using a depth mapping device with a texture camera mounted on a robot are depicted. Image 704 depicts an embodiment in which only the texture camera image is mapped onto the 2D position data array, corresponding to 2D array 360 of FIG. 3D. Image 708 depicts an embodiment of an augmented-reality image showing a range of distance between a tool and an object corresponding to 2D array 370 of FIG. 3D. Red may indicate that this area of the object is too close from the tool, green may indicate that this part of the object is within the optimum range, and blue may indicate that this area of the object is slightly too far from the tool. In various embodiments of the present disclosure, the visual element from image 704 presented in augmented-reality image 708 may help the operator to determine what areas of the object are too close or too far away. Image 712 depicts an embodiment of an image showing distance information encoded using the same method used for image 708 but without the texture image elements of image 704. In an embodiment of the present disclosure, image 712 may show only elements that are within the distance ranges corresponding to red, green, and blue colors. In the present disclosure, images 708 and 712 were converted to gray colors. Consequently, the light-gray area in image 708 relative to image 704 corresponds to the green color, and image 712 shows only the green elements of image 708. Red and blue colors are not apparent in images 708 and 712.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A depth-measuring system for robotic applications comprising:
a robot;
a tool attached to the robot and having a reference point;
an illuminator that emits energy installed on the tool to illuminate an object; and
at least one energy receiver that is installed on the tool and detects at least some energy reflected by the object in response to the energy emitted by the illuminator.

2. The depth-measuring system of claim 1 where the illuminator emits energy according to a two-dimensional pattern.

3. The depth-measuring system of claim 2 wherein the two-dimensional pattern comprises a dot pattern where the dots are uncorrelated in a pseudo-random or random pattern.

4. The depth-measuring system of claim 2 wherein the two-dimensional pattern changes as a function of time.

5. The depth-measuring system of claim 1 wherein the at least one energy receiver comprises a two-dimensional sensor.

6. The depth-measuring system of claim 1 wherein the at least one energy receiver has a pre-determined spatial relationship with the reference point on the tool.

7. The depth-measuring system of claim 6 wherein the illuminator has no pre-determined spatial relationship with the at least one energy receiver.

8. The depth-measuring system of claim 1 further comprising:
a camera installed on the robot and having a pre-determined spatial relationship with the at least one energy receiver, wherein the camera acquires images of the object and its surrounding environment.

9. The depth-measuring system of claim 8 further comprising:
a processing unit that uses the energy received by the at least one energy receiver to determine the three-dimensional spatial coordinates of at least one point on the object for at least one data point provided by the at least one energy receiver.

10. The depth-measuring system of claim 9 wherein at least one pixel of an image acquired by the camera is associated to the at least one data point provided by the at least one energy receiver to produce a second image.

11. The depth-measuring system of claim 10 wherein the second image is modified by a processing unit to add distance or orientation information to create a third image using three-dimensional spatial coordinates of at least one data point provided by the at least one energy receiver.

12. The depth-measuring system of claim 11 wherein the three-dimensional coordinates of the at least one point on the object provided by the at least one energy receiver are used to determine the three-dimensional coordinates of the location of an industrial process on the object.

13. The depth-measuring system of claim 12 wherein at least one data value of the industrial process on the object is associated to the closest data point of the at least one energy receiver according to their respective three-dimensional spatial coordinates.

14. The depth-measuring system of claim 13 wherein the value of a pixel of the second image associated to the data point of the energy receiver that is the closest to the location of the industrial process on the object is modified to produce a fourth image according to industrial process data at that location.

15. The depth-measuring system of claim 14 wherein the industrial process data are ultrasonic inspection results.

16. The depth-measuring system of claim 1 wherein the system forms part of an ultrasonic testing system.

17. The depth-measuring system of claim 16 wherein ultrasonic energy is generated in the object along an optical path originating from a point, wherein the point has a pre-determined spatial relationship with the reference point.

18. The depth-measuring system of claim 17 wherein the position of the point where ultrasonic energy is generated in the object is determined using information provided by the at least one energy receiver, a pre-determined relationship between the at least one energy receiver and the reference point, and controllable parameters of the optical path.

19. The depth-measuring system of claim 9 wherein three-dimensional spatial coordinates are provided by the at least one energy receiver, the three-dimensional spatial coordinates being used to calculate surface normal of at least one point on the object.

20. The depth-measuring system of claim 19 wherein the three-dimensional spatial coordinates are used to make a real-time determination of whether the object lies within a pre-determined range of distance.

21. The depth-measuring system of claim 1, the tool further comprising:
a rotation axis.

22. The depth-measuring system of claim 21 wherein the at least one energy receiver is mounted on a portion of the tool that rotates relative to the robot.

23. The depth-measuring system of claim 9 further comprising:
a processing unit that calculates the position of at least one point of the object relative to the reference point using the three-dimensional spatial coordinates of at least one point on the object for at least one data point provided by the at least one energy receiver and a pre-determined spatial relationship between the reference point and the at least one energy receiver.

24. A method to perform an industrial process comprising:
moving a robot near an object;
acquiring a two-dimensional array of depth data using a depth mapping device and a two-dimensional optical pattern;
performing an industrial processing step on the object;
using the two-dimensional array of depth data to determine the location of the industrial processing step being performed on the object and to generate coordinates of the location; and
storing the two-dimensional array of depth data and the coordinates of the location of the industrial processing step being performed on the object.

25. A method to perform an industrial process comprising:
moving a robot near an object;
acquiring depth data using a depth mapping device and a two-dimensional optical pattern;
acquiring a texture image using a camera having a pre-determined spatial relationship with the depth mapping device; and
associating a portion of the pixels of the texture image with a portion of the depth data using a calibration located on the depth mapping device.

26. The method of claim 25 further comprising:
determining three-dimensional spatial coordinates of a portion of the depth data relative to a coordinate system of the depth mapping device.

27. The method of claim 25 further comprising:
determining three-dimensional spatial coordinates of a portion of the depth data relative to a reference coordinate system

28. The method of claim 27 further comprising:
modifying at least a portion of the pixels of the texture image based on range values calculated using the three-dimensional spatial coordinates relative to the reference coordinate system.

29. The method of claim 27 further comprising:
associating industrial process results to a portion of the texture image using three-dimensional spatial coordinates to produce a modified texture image that provides visual information about the industrial process results and their locations on the object.
